(19) United States
(12) Patent Application Publication
(10) Pub. No.: US 2009/0176160 A1
(43) Pub. Date: Jul. 9, 2009

(54) ELECTROACTIVE SEPARATOR FOR OVERCHARGE PROTECTION

(76) Inventor: Aron Newman, Cambridge, MA (US)

Correspondence Address: PROSKAUER ROSE LLP, ONE INTERNATIONAL PLACE, BOSTON, MA, 02110, US

(21) Appl. No.: 12/133,598

(22) Filed: Jun. 5, 2008

Related U.S. Application Data
(60) Provisional application No. 60/942,331, filed on Jun. 6, 2007.

(51) Int. Cl. H01M 2/16

(52) U.S. Cl. 429/248; 264/331.11; 429/254

(57) ABSTRACT

A separator for a battery that includes a first polymer to provide structural support and a second polymer mixed with the first polymer. The second polymer provides an open channel for ionic transport through the separator. The separator also includes a third polymer interspersed with the first polymer and the second polymer. The third polymer is an insulator when a potential in the battery is less than a switching voltage, and is a conductor when the potential in the battery is greater than the switching voltage.

### CROSS-REFERENCE TO RELATED APPLICATION

This application claims the benefit of and priority to U.S. provisional patent application No. 60/942,331 filed on Jun. 6, 2007, which is owned by the assignee of the instant application and the disclosure of which is incorporated herein by reference in its entirety.

### GOVERNMENT SUPPORT

The subject matter described herein was supported in part by the Department of Energy under Grant No. DE-FG02-05ER84249 and FA9300-05-M-3104. The U.S. Government may have certain rights in the technology.

### FIELD OF THE INVENTION

The invention generally relates to a battery separator. In particular, the invention relates to a porous electroactive composite polymer separator to protect batteries from overcharging.

### BACKGROUND OF THE INVENTION

Lithium-ion cells need to be charged to a specified cut-off voltage to maintain safe operation and to achieve high cycle and calendar life. Generally, lithium-ion cells are used in battery packs with cells in series, e.g., laptop computers and hybrid electric vehicles. Even when cells are balanced for capacity and impedance, the capacity fade of the battery can vary. Cell to cell capacity variations can result in overcharging of the low capacity cells without additional monitoring and control circuitry.

External control circuitry can be expensive and ineffective. Controlling overcharge with either a redox shuttle or with an electroactive polymers had limited success due to voltage and current density constraints. Redox shuttles decompose at the charging voltages of commercial lithium-ion cells and can not carry sufficient current. Electroactive polymers have been suggested for controlling overcharge, but also have voltage and current density limitations. The polymer film switches from an insulator to a conductor upon overcharging. After the charging current is removed, the polymer returns to an insulator. The shortcomings are due to the low oxidation potential and low loading of the electroactive polymer into an industry standard separator.

### SUMMARY OF THE INVENTION

The invention, in one embodiment, features an electroactive separator that can reversibly become conductive when a cell reaches an overvoltage condition, shunting electrons between the electrodes at current densities up to 10 mA/cm². At cell operating voltages, the porous separator functions as a typical ion shuttle. For manufacturing concerns, the tensile yield strength of the durable film is about 6.8 MPa (normalized force to film width of 0.17 N/mm) and can be stronger depending on the selection of the binder. The separator can contain electroactive poly(alkylthiophene) as an integral component of the separator rather than as an added polymer to an existing separator, while not compromising porosity. Higher overcharge current density shunting can result.

An electroactive separator can include three general components: a binder, an electroactive polymer, and an electrolyte soluble polymer. The binder can provide structural support but can also provide some ionic transport due to its soak-up of electrolyte. The binder can be a structural member polymer. The electroactive polymer can be selected from a family of polymers that can reversibly oxidize and reduce, switching between a conductor and an insulator. The electroactive polymer can be a structural member. The electrolye-soluble polymer provides an open channel for ionic transport. The channel can have a tortuous pathway that prevents lithium dendrites from shorting the cell. The tortuous pathway coupled with the mechanical integrity of a solid polymer film during fabrication can allow for thinner separators to be used in a cell.

In one aspect, the invention features a separator for a battery which includes a first polymer to provide structural support. A second polymer is mixed with the first polymer and provides an open channel for ionic transport through the separator. A third polymer is interspersed with the first polymer and the second polymer. The third polymer is an insulator when a potential in the battery is less than a switching voltage, and is a conductor when the potential in the battery is greater than the switching voltage.

In another aspect, the invention features a method for forming a separator for a battery. At least a first polymer and second polymer are dissolved in a solvent to form a mixture. A non-solvent is added to the mixture to form a precipitate of the first polymer and the second polymer. A layer of electroactive polymer is formed from the precipitate.

In yet another aspect, the invention features a battery device that includes anode particulates spaced from cathode particulates. A porous electroactive composite polymer is disposed between the anode particulates and the cathode particulates to protect the battery from overcharge.

In other examples, any of the aspects above, or any apparatus or method described herein, can include one or more of the following features.

In some embodiments, the first polymer is poly(vinylidene difluoride), the second polymer is poly(ethylene oxide) and the third polymer is poly(3-hexythiophene). The third polymer can control the switching voltage. The third polymer can be reversibly switchable between the conductor and the insulator. In some embodiments, the switching voltage is about 3.6V to about 3.95V.

In some embodiments, the third polymer is interspersed with the first and second polymer without compromising the porosity of the separator. The first polymer can have a weight percentage of about 10% to about 60%. The second polymer can have a weight percentage of about 30% to about 60%. The third polymer can have a weight percentage of about 10% to about 50%.

The separator can have a thickness of about 8 μm to about 25 μm. In some embodiments, the separator has a tortuosity factor of about 3.

The method for forming a separator for a battery can also include melting the precipitate and applying pressure to the precipitate to form the separator. In some embodiments, the separator is formed by melting the precipitate and extruding the precipitate melt to form the separator. A shear force can also be applied to the precipitate to form the separator. In some embodiments, the first, second and third polymers can be dissolved in a solvent to form a mixture. The precipitate can include the first, second and third polymers.

In some embodiments, the precipitate includes the first and second polymer and a third polymer is dissolved with the precipitate in a solvent to form a suspension. The suspension can be cast on a film to form the separator. The film can be a substrate for roll-to-roll processing. The film can include an agent to remove the separator.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic of a separator for a battery, according to an illustrative embodiment of the invention.

FIG. 2A is a schematic of a cathode, anode and separator acting as an insulator, according to an illustrative embodiment of the invention.

FIG. 2B is a schematic of the cathode, anode, and separator of FIG. 3B acting as a conductor, according to an illustrative embodiment of the invention.

FIG. 3 is a schematic of an apparatus used to cast polymer film to manufacture a separator for a battery, according to an illustrative embodiment of the invention.

FIG. 4 is a graph showing a current as a function of voltage for an electroactive polymer.

FIG. 5 is a graph showing current as a function of voltage for an electroactive polymer.

FIG. 6 is a drawing of an electroactive composite polymer separator, according to an illustrative embodiment of the invention.

FIG. 7 is a graph comparing results of overcharging an industry standard separator with a separator.

FIG. 8 is a graph showing results of overcharging another industry standard separator with a separator.

FIG. 9 is a graph showing a discharge capacity of a separator.

FIG. 10 is a graph showing charge, overcharge and discharge of two electroactive composite polymer separators.

FIG. 11 is a graph showing overcharge of separators.

FIG. 12 is a graph showing the voltage levels experienced by a separator.

FIG. 13 is a graph showing different voltages experienced by industry standard separators and separators.

FIG. 14 is a graph showing voltage levels experienced by separators with varying levels of electroactive polymer concentration.

FIG. 15 is a graph showing the effect of concentration of electroactive polymer on the average voltage experienced by a separator.

FIG. 16 is a graph showing the electrochemical performance of a separator.

FIG. 17 is a graph showing electrochemical performances of different separators.

FIG. 18 is a graph showing electrochemical performances for separators.

FIG. 19 is a graph showing electrochemical performances of a separator.

FIG. 20 is a graph showing the tensile load as a function of displacement for a separator film.

### DETAILED DESCRIPTION OF THE INVENTION

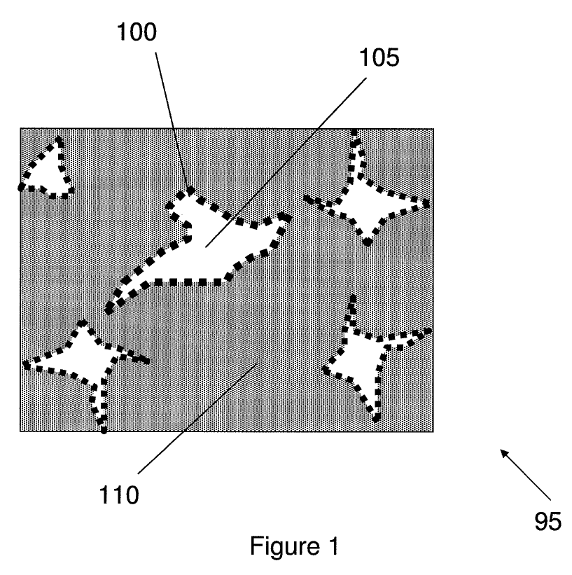

FIG. 1 is a schematic of a separator 95 (e.g., a porous electroactive composite polymer separator) for a battery, according to an illustrative embodiment of the invention. The separator 95 includes a first polymer 100 to provide structural support and a second polymer 105 mixed with the first polymer. The second polymer 105 provides an open channel for ionic transport through the separator. The separator 95 also includes a third polymer 110 interspersed with the first polymer 100 and the second polymer 105. The third polymer 110 can be an insulator when a potential in the battery is less than a switching voltage, and can be a conductor when the potential in the battery is greater than the switching voltage.

The separator 95 can be used to protect batteries (e.g., lithium ion batteries) from overcharging. Low capacity cells in a series configuration can be overcharged, despite starting with a balanced battery pack. Overcharging a battery can attack cells, cause corrosion of current collectors, attack electrolytes, and cause electrode delamination. Overcharging degrades performance, decreases cycle life and increases internal impedance, producing less power from the battery. The separator 95 (e.g., an electroactive polymer separator) can reversibly switch to a conductor at 3.9 volts and sustain overcharge current of 10 mA/cm². The switching voltage and overvoltage upon overcharging can be tuned for the desired battery couple with the selection of the electroactive polymer. In some embodiments, the switching voltage of the separator 95 is about 3.6 V to about 3.95 V. The separator 95 has the potential to carry sufficient tensile load to be processed with conventional winding equipment. The grain boundary phase electroactive polymer 110 provides a conductive pathway.

In some embodiments, the separator is a blend of three commercially available polymers: poly(3-hexythiophene) (P3HT), poly(vinylidene difluoride) (PVDF), and poly(ethylene oxide) (PEO). PVDF can act as the first polymer 100 (e.g., primary support structure) that provides its mechanical strength for roll-to-roll processing. In some embodiments, Torlon, a polyamide-imide, can be used as the first polymer 100. PEO can be used as the second polymer 105 (e.g., a polymer soluble in the organic carbonate battery electrolyte) and can provide the primary lithium ion pathway through the separator. P3HT can be used as the third polymer 110 (e.g., an electroactive polymer) that switches between conductor and insulator. The separator (e.g., separator including P3HT as the electroactive polymer) can provide enhanced overcharge protection while retaining state of the art battery (e.g., Li ion battery) performance.

The composite separator 95 can have a 30 to 60% pore volume filled with a second polymer 105 (e.g., electrolyte) that provides ion transport (e.g., lithium ions). The third polymer 110 (e.g., electroactive polymer) chemistry is selected to reversibly switch from an insulator to a conductor in order to protect the electrodes from overvoltage conditions. This feature can prolong calendar and cycle life. The third polymer 110 (e.g., electroactive polymer) component of the separator can serve two functions: structural support and overcharge protection. The third polymer 110 does not readily soak up the organic carbonate solvents that are typically used in lithium ion cells, while the first polymer 100 (e.g., PVDF) does. In some embodiments, PVDF is used as the first polymer that acts as a binder for the electrode materials and the soak-up of electrolyte allows for improved ion transport. The swelling of the PVDF can degrade its mechanical integrity. In some embodiments, particulate poly(thiophene) used as the third polymer 110 can provide support to the separator 95 to ensure that the barrier between the anode and cathode is maintained.

The third polymer 110 (e.g., electroactive polymer) can maintain its neutral state as an insulator during typical charging and discharging. The third polymer 110 can control the switching voltage and can be reversibly switchable between a conductor and insulator. Upon overcharging, in which the potential is greater than a threshold value (e.g., 3.8 volts for P3HT), or the switching potential, the electroactive polymer can switch to a conductor and serves as a current shunt. When the cell potential returns to voltages below its switching potential, the electroactive polymer can return to an insulator state. This active in-situ reversible mechanism controls overcharge for electrode charge rates up to 10 mA/cm², which is nominally equivalent to full cell charging at 15 C-rates. The third polymer 110 can be interspersed with the first polymer 100 and the second polymer 105 without compromising a porosity of the separator. High power performance will not be compromised by this composite because its porosity maintains high lithium-ion mobility. Battery safety can be improved by the tortuous pathway provided by the pores in this separator that impedes lithium dendrite growth. The tortuosity factor of the separator is the distance traveled to pass through a film divided by the thickness of film. In some embodiments, the separator has a tortuosity factor of about 3. For performance needs, tortuosity should be low to allow for high lithium diffusion rates, providing improved battery performance. In some embodiments, the tortuosity is higher than traditional separators, but the lithium diffusion rates can be equivalent by decreasing the separator's thickness. In some embodiments, the thickness of the separator is from about 6 μm to about 25 μm.

Depositing the third polymer 110 into porous polymer separator 95 (e.g., polyethylene separator) can decrease the porosity of the separator 95. The low level of loading limits the separator's ability to pass current as the polymer is activated upon reaching its oxidation potential. In addition, decreased separator porosity compromises high power performance which is critical to batteries such as hybrid-electric vehicle batteries.

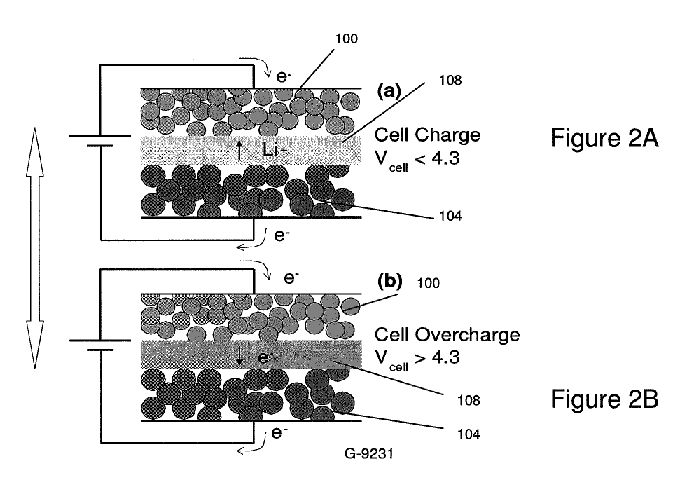

FIGS. 2A and 2B are schematics of a cathode 100, anode 104 and a separator 108, according to an illustrative embodiment of the invention. In some embodiments, the battery device includes anode 104 and cathode 100 electrodes that include an electrochemically active material, conductor, and binder. The anode 104 and the cathode 100 can be in close proximity but physically separated. A separator 108 can be disposed between the anode 104 and cathode 100 electrodes. In some embodiments, the battery device includes anode particulates (e.g., anode 104) and cathode particulates (e.g., cathode 100) spaced from the anode particulates. The battery device can also include a separator 108 (e.g., a porous electroactive composite polymer) disposed between the anode particulates and the cathode particulates to protect the battery from overcharge. FIGS. 2A and 2B illustrate the two functioning modes of the electroactive polymer of the separator, according to the illustrative embodiment.

The electroactive polymer separator (e.g., separator as described above in FIG. 1) at threshold voltage can reversibly switch from an insulator to conductor. The electroactive polymer (e.g., third polymer 110 in FIG. 1) can be a structural component of separator. As shown in FIG. 2A, during normal charge and discharge cycling, the electroactive polymer in the separator can be an insulator passing only lithium-ions, while not passing any electrons between the electrodes (e.g., V_{cell}<3.8), the anode 100 and the cathode 104. As shown in FIG. 2B, however, when the cell is overcharged (e.g., V_{cell}>3.8), the electroactive polymer can switch to a conductor permitting electrons to pass between the electrodes and causing the battery to short. The threshold voltage of 3.8 V is specifically designed for the lithium iron phosphate-based cathode. The shorted battery protects the cathode from reaching voltages that degrade the cell. Charging can be actively controlled by utilizing an electroactive polymer based separator 108 (e.g., the separator as described above in FIG. 1) by generating a conductive shunt between the electrodes. When the cell is no longer charging, the voltage drops to the open-circuit voltage (OCV) of the cathode, and the separator returns to an insulator state. In this embodiment, the target threshold switching voltage was 3.8 volts. In some embodiments, a target threshold switching voltage from about 3.6 volts to about 4.0 volts has been achieved with the electroactive polymer (e.g., electroactive poly(alkylthiophene)).

The separator can augment the less effective, high cost diode circuitry and individual cell monitoring used for external control of overcharging cells in a battery pack. The overcharge control can improve battery pack calendar and cycle life compared to external or no control, i.e., in-situ cell balancing. The electroactive separator can provide higher current density and more stability than redox shuttle molecules, an alternate overcharge control mechanism. The electroactive polymer (e.g., third polymer 110 in FIG. 1) can be an integral component of the separator, and not a pore-blocking add-on to an existing separator.

The anode can include graphite particles. Commercially available plate-like graphite/carbon particles, e.g., graphite particles available from Superior Graphite, can be used. The cathode can include cathode particulates that can include ceramic nanoparticles. A cathode material that can be used with an electroactive polymer (e.g., P3HT-regioregular) is lithium iron phosphate. Any cathode can be used by matching a suitable electroactive polymer that has a switching voltage greater than the charge voltage of the cathode.

The electroactive polymer separator can be fabricated from a blend of three cast polymers. Tetrahydrofurane (THF) solvent can be used, but there are other solvents that can be used. The separator can include a first polymer acting as the binder (e.g., poly(vinyldene difluoride)), a second polymer acting as an electrolyte soluble polymer (e.g., a battery electrolyte soluble polymer such as poly(ethylene oxide)), and a third polymer (e.g., electroactive polymer such as electroactive poly(alkylthiophene)) acting as the conductive polymer (e.g., P3HT). A range of compositions can be effective as serving as a control vehicle for overcharge protection and function as a separator. In some embodiments, the separator has a range of P3HT content that can be about 10 wt % to 40 wt %; a range of PEO content that can be about 30 wt % to 60 wt %; and a range of PVDF content that can be about 10 wt % to 60 wt %. These solutions can be cast on glass for multiple passes to build separators in the range of thickness from 15 μm to 25 μm.

In some embodiments, the tortuosity factor of the separators can be about 3 to about 10. Commercially available separators can have a tortuosity factor less than about 2 while still blocking lithium dendrites from crossing through the separator.

The porosity can be created in-situ with selective dissolution of the soluble polymer. For example, the separator can be made using a solution/suspension casting method. In some embodiments, the process creates a solution with PEO and PVDF dissolved that also contains P3HT particles suspended in this solution. The solvent can be N-Methylpyrrolidone (NMP) or Tetrahydrofurane (THF). In NMP, P3HT is insoluble while PEO and PVDF are soluble. NMP can be used for large-scale manufacturing operations.

Small particles of P3HT can be dispersed in the separator film. A solvent/non-solvent pairing can be used to fabricate the micron-sized particles. For example, chloroform/isopropanol or THF/ethylene glycol can be used. PEO and P3HT can be dissolved in chloroform, and then isopropanol can be added to this solution resulting in the precipitation of the PEO and P3HT. The chloroform and isopropanol can be removed by rotary evaporation in which the chloroform evaporates first. The solid remaining is a well mixed blend of PEO and P3HT with particles on the order of 1 micrometer. This polymer blend can be dissolved in NMP, and with ultrasonic mixing, the P3HT particles can be suspended in the NMP solution. PVDF can be added to this solution so that the final solution has a solids loading from 10% to 30%.

A method for forming a separator for a battery can include dissolving at least a first polymer and a second polymer in a solvent to form a mixture, adding a non-solvent to the mixture to form a precipitate of the first polymer and the second polymer and forming a layer of electroactive polymer from the precipitate. In some embodiments, the method includes dissolving a third polymer in the solvent to form the mixture and a nonsolvent is added to form a precipitate of the first polymer, second polymer, and third polymer. The separator can be an interpenetrating network of the three polymers including the precipitate electroactive polymer. In some embodiments, the first polymer is poly(ethylene oxide) and the second polymer is a poly(vinylidene difluoride). The third polymer can be poly(3-hexythiophene).

In some embodiments, the method includes melting the precipitate and applying pressure to the precipitate to form the separator. The separator can be formed by melting the precipitate and extruding the precipitate melt to form the separator. The method can include the step of applying a shear force to the precipitate to form the separator. In some embodiments, melt processing includes extrusion and blow molding to form the separator.

In some embodiments, the method includes dissolving the precipitate in a second solvent and mixing the third polymer to form a suspension. In some embodiments, the precipitate includes the first and second polymer and a third polymer is dissolved in a solvent to form a solution that contains suspended particles of the third polymer. In some embodiments, the suspension is cast on a film to form the separator. The film can be a substrate for roll-to-roll processing. In some embodiments, the can include a release agent coating to enable separator removal and uniform overage of the cast coating.

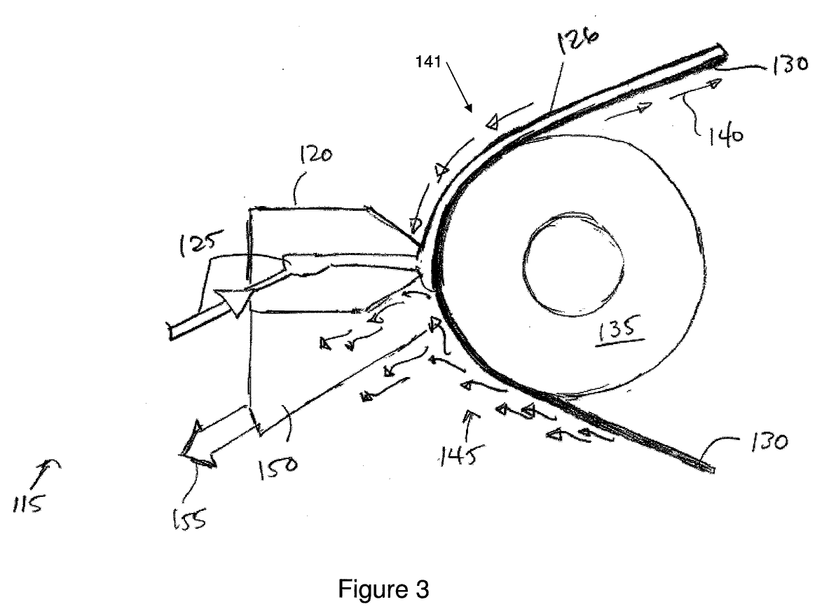

FIG. 3 is a schematic of an apparatus 115 used to cast the polymer film. The apparatus 115 allows for continuous casting process. The apparatus 115 includes a slot-die 120 that injects the solvent 125 on to a film 130. The film 130 is wound on a roller 135 and the film 130 can travel in the direction indicated by arrows 140. The separator film 126 on the film 130 can have a surface tension as indicated by arrows 141. The separator film 126 can be dried (e.g., the solvent evaporated) from air 145, which is aided by heating from top and bottom. Forced heated air 145 provides low friction and higher evaporation rates. A vacuum chamber 150 forces boundary layer air 145 to flow in the direction indicated by arrow 155. The solution/suspension 125 can be cast on a film 130 (e.g., Mylar (polyester) film) with a release agent to aid with the removal of the separator 126. In some embodiments, the cast can result in localized thinning, which can be minimized by using a different release film 130. Mylar film can be used as the substrate 130 for solution casting the separator roll-to-roll processing. The separator film 126 can be applied on the Mylar polyester backing 130 and wound to take-up roller 135. The separator film 126 can readily release from film 130 (e.g., polyester film) backing. The solvent retention in coating can be less than 1 wt %. The “slot-die” coating invention can be scalable to a width up to 2 meters. The film thickness can be about 10 μm to 100 μm. In some embodiments, multiple castings are done to form the separator. Slot-die 120 solvent casting provides low variation coating.

In some embodiments, an electroactive separator can be fabricated in 60 mAh pouch cells, as compared to previous coin cells with 2 mAh capacity. In some embodiments, 2 layers of 7 micron thick separator are formed.

The separator can also be made using a melt/coldworking method. Melt processing allows for the micrometer-scale distribution of three continuous phases: P3HT, PEO, and PVDF. The mixing process can be performed by the above-described with the solvent/non-solvent process that produces fine precipitates of the three polymers or, alternatively, a melt compounding process can be used to produce pellets including a blend of these three polymers. In some embodiments, 25 micrometer films are formed via mixing using precipitation and cold rolling of this mixed polymer.

In some embodiments, the three polymers can be mixed with one another with a solvent. A nonsolvent can be added to form a precipitate of the three polymers. It is also possible to mix a first and second polymer with a solvent and add a nonsolvent to form a two-polymer precipitate. The casting solvent, e.g. NMP or dimethylacetamide (DMAC), can dissolve one of the two precipitate polymers and can dissolve the added third polymer. Heat can be applied to the precipitate of the three polymers and pressure can be used to form the separator to a desired thickness. The precipitate of the three polymers can also be melted and extruded to form the separator. A shear force can be applied to the precipitate of the three polymers to form a separator to a desired thickness.

Separators can be made by applying an electroactive polymer to an existing separator. However, the method of applying an electroactive polymer to an existing separator can compromise the porosity of the separator since coating the electroactive polymer to an existing separator fills the pores of the separator with the electroactive polymer. Compromising the porosity of the separator affects the ability of ions to travel through the separator, which can affect the performance of the separator. Interspersing and integrating the electroactive polymer into the separator avoids compromising the porosity and performance of the separator, facilitating ionic transport.

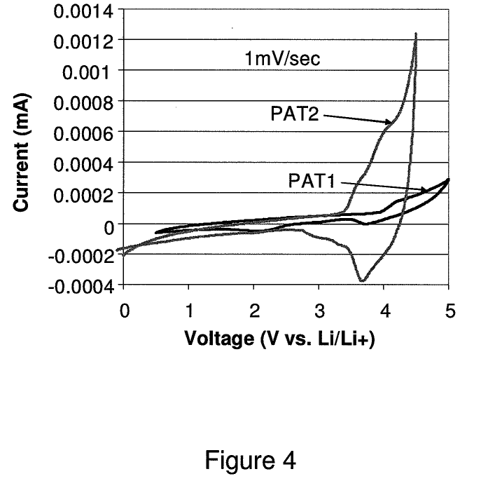

FIG. 4 shows cyclic voltammograms were produced on candidate PATs for selecting the appropriate electroactive poly(alkylthiophene) (PAT). Cyclic voltammatry (CV) was performed on poly(alkylthiophene) in flooded cell versus lithium as counter and reference. FIG. 4 shows two types of poly(alkylthiophenes) (PAT). The PAT was regiorandom poly(3-hexylthiophene). With the selection of the type of electroactive polymer (e.g., PAT), the oxidation potential can be tuned for different electrode couples. The oxidation potential difference between these two types of polymers is 500 mV. Higher oxidation potential PAT results in a lower conductivity. PAT1 was desirable as compared to PAT2 due to its higher oxidation potential. Sample PAT2 with a lower oxidation potential is more conductive, as indicated by the larger measured current, while testing at the same scan rate of 1 mV/sec. Table 1 lists the experimental formulations investigated and their sample identification.

TABLE 1
Sample Descriptions

| Sample ID | Relative PAT Level |
|---|---|
| 1XPT | Base level of PAT |
| 3XPT | 3 × PAT |
| 4XPT | 4 × PAT |
| 5XPT | 5 × PAT |

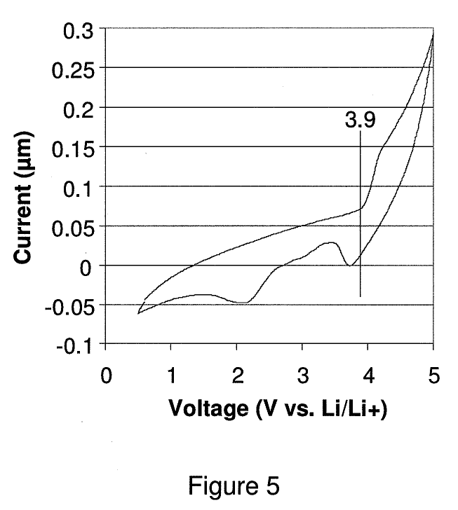

FIG. 5 shows the results of a cyclic voltammogram at 1 mV/sec using PAT1, which was used as the active component of the separator. Note that the oxidizing voltage is ˜3.9 volts and the reduction peak is ˜3.7 volts. Nevertheless, the OCV is 3.96 volts with the experimental polymer film for a fully charged cell. This higher OCV may be attributed to cell polarization across the separator that produces conditions to switch the electroactive polymer to an insulator on the anode side of the separator. In addition, the finely distributed electroactive polymer may be more electrochemically addressable, i.e. improved kinetics, than the fully dense thin film on the Pt.

The solvent and polymer types can be selected to get solubility of all three components: binder, PAT, electrolyte soluble polymer. The fabrication of a separator can involve dissolving the three component polymer blend in a polar aprotic solvent. Due to the polymer blend's limited solubility, multiple passes of solution can be used cast to build the separator film. With multiple layers it is possible to get conductive pathway, however, the number of passes should be kept to a minimum in order to ensure a conductive pathway through the separator. In fabricating the separator, it is desirable to achieve a thinner separator for improving electron and ion transport, however, a thicker separator avoids cell shorting. For example, a separator that is twice as thin can provide for an increase in the cell's energy density. In some embodiments, a thinner separator (8 mm vs. ˜20 mm) increases a battery cell's energy density.

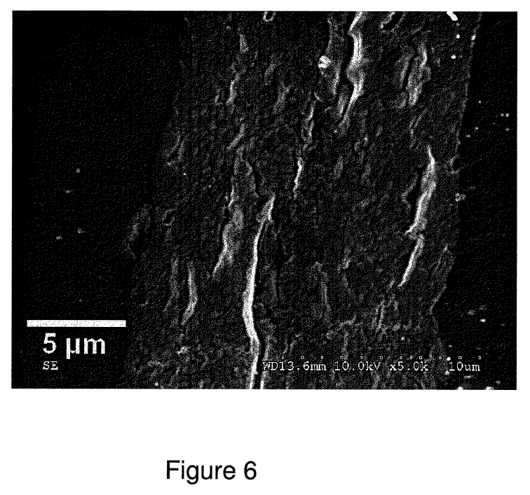

FIG. 6 is a drawing of a sample separator (e.g., 5XPT). The in-situ created open structure, an electrolyte conduit, is formed by the dissolution of one of the three polymers in the film. The conductive pathway is provided by the elongated regions of the electroactive polymer. Porosity can be formed in the balance of the film where this two-phase region contains the binder and electrolyte-soluble polymer. In the embodiment shown in FIG. 6, the thickness of the cross-sectioned film is 18 μm. Fabricated separators range in thickness from 12 μm to 30 μm.

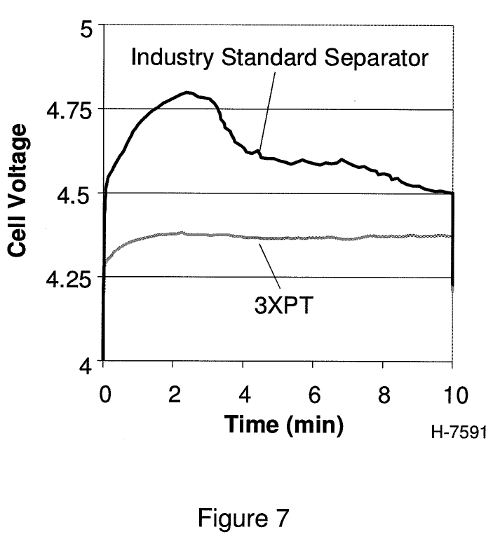

FIG. 7 shows a comparison between overcharging an industry standard separator with a separator. The sustained overcharge current density for the industry standard separator was 6 mA/cm² while the 5XPT separator formed according to the invention performs at less than 2.3 mA/cm². This lower voltage on overcharging will improve cycle and calendar life. The voltage of the industry standard separator peaks at 4.8 V, and the drop in voltage is attributed to corrosion of the components within the cell, either on the cathode or anode.

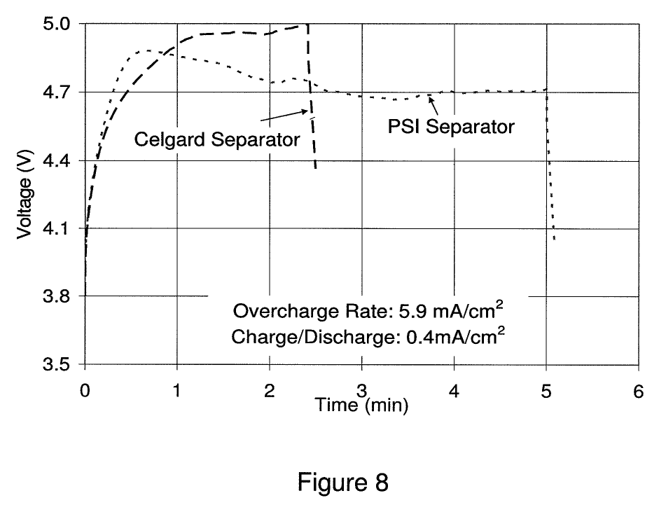

FIG. 8 shows the operation of a separator compared to a Celgard 2400 commercial separator. The separator according to an illustrative embodiment includes 10 wt % P3HT regioregular, 30 wt % PEO (240K molecular weight), and 60 wt % PVDF co-polymer (Kynar grade 2801). At two and a half minutes, Celgard reached the cell tester's maximum voltage of 5 volts due to an overcharge current of 6 mA/cm². If the Celgard test is not stopped, the voltage continues to increase. The separator in FIG. 8 switches at ˜45 seconds and stabilized overvoltage at 4.7 volts.

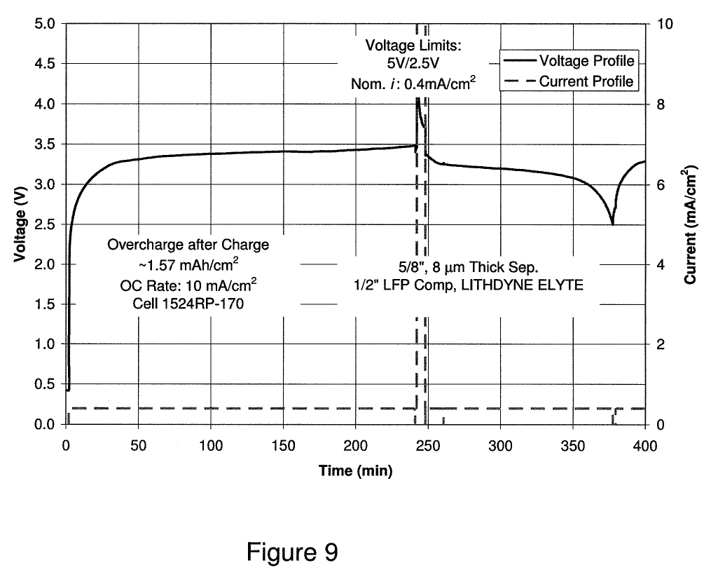

FIG. 9 shows a discharge capacity of an electroactive composite polymer separator. A cell was charged to 2 mAh (1.57 mAh/cm²) over a period of 250 minutes prior to overcharge. Overcharging at 10 mA/cm² was stopped after 6 minutes to demonstrate discharge capacity (0.85 mAh/cm²). As the charging current density was increased from 1.57 mAh/Cm² to 10 mAh/cm², the cell voltage increased and the separator switched to a current shunt. This separator switching resulted in a voltage drop.

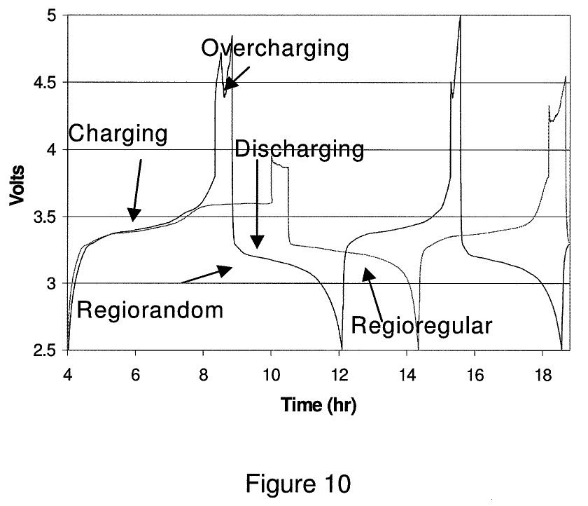

FIG. 10 shows charge, overcharge, and discharge of two separators. The first separator included P3HT regiorandom as the electroactive polymer while the second separator included P3HT regioregular as the electroactive polymer. The ½″ diameter electrodes are lithium iron phosphate and graphite, and the electrolyte is 1M LiPF₆ in 1:1 EC:DMC. The cell was charged to 3.8 V at 500 μA (394 μA/cm²) current, overcharged at 5 mA (3.94 mA/cm²) current, and discharged at 500 μA (394 μA/cm²) current. As seen in FIG. 10, P3HT regioregular shows superior performance to the P3HT regiorandom due to the order of magnitude greater conductivity. The in-cell switching voltage of P3HT regiorandom is 3.95 V while the in-cell switching voltage of P3HT regiorandom is 3.6 V. The lower switching voltage is appropriate for the lithium iron phosphate cathode because the cell can be fully charged before the separator switches.

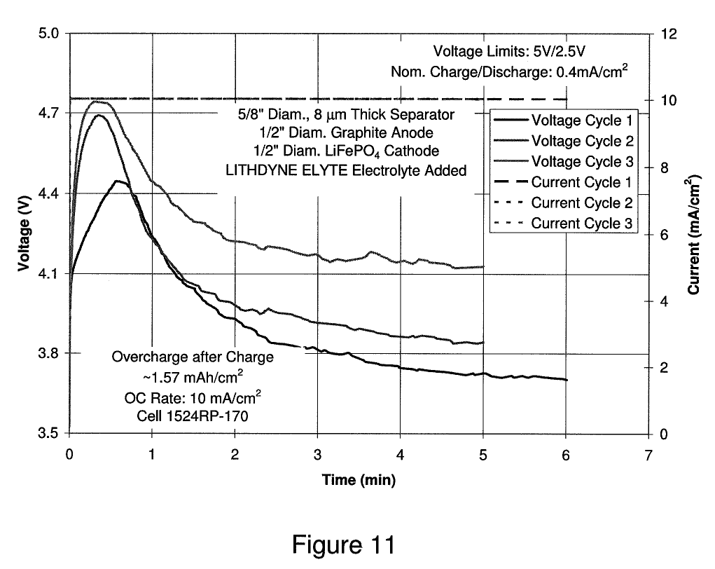

FIG. 11 shows charge, overcharge, and discharge of electroactive composite polymer separators. In this embodiment, the separator was ⅝ inches in diameter and 8 μm thick. The battery tested included a ½ inch diameter graphite anode and a ½ inch diameter LiFePO₄ cathode. As shown in FIG. 11, the separators switch to act as a conductor after 30 seconds of overcharging. After switching to a conductor, the overcharge voltage continues to drop as the separator is reversibly oxidized.

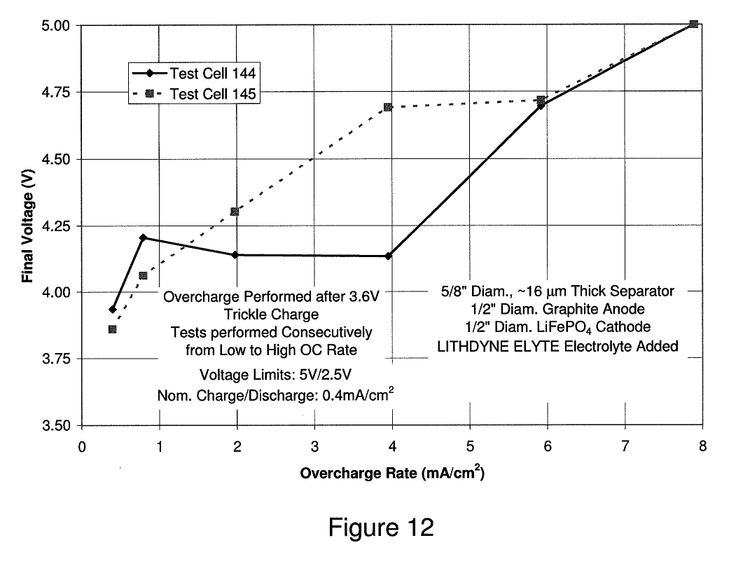

FIG. 12 shows the voltage levels experienced by an electroactive composite polymer separator for varying overcharge rates. The separator tested in FIG. 12 was a ⅝ inch in diameter and approximately 16 μm in thickness. For overcharge rates ranging from about 0.5 mA/cm² the separator experienced maximum voltage levels ranging from 3.8 V to about 5 V.

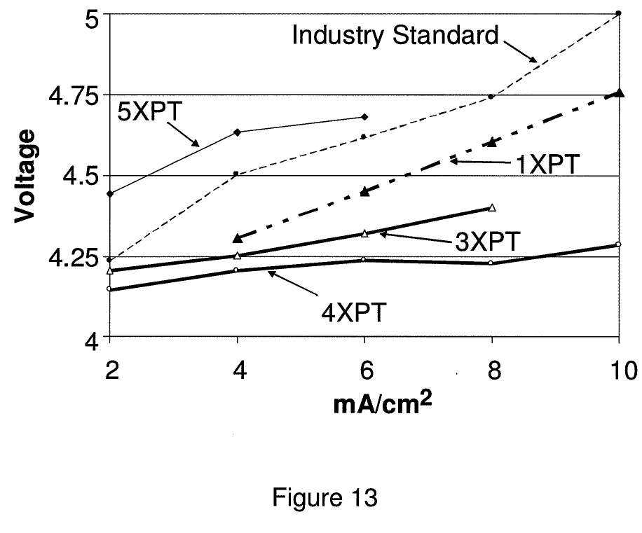

FIG. 13 shows different voltages experienced by industry standard separators and separators. The difference between the separators (e.g., separators as described above in FIG. 1) was the concentration of electroactive polymer used in the separator. For example, separator “5XPT” has a greater concentration of electroactive polymer than “5XPT” which has a greater concentration of electroactive polymer than “5XPT” or “5XPT”. FIG. 13 shows the voltages of fully charged cells after applying current densities in the range from 2 mA/cm² to 10 mA/cm² at 5 minutes for each current density. The current density, experienced by the electrodes in an HEV battery pack, during pulse charging is expected to be lower than 10 mA/cm². The separators tested (5XPT, 5XPT, and 5XPT) performed at advantageously lower voltages than the industry standard separator except sample 5XPT. This sample's microstructure may have limited porosity or lack a conductive pathway. In general, adding more of the conductive phase (e.g., electroactive polymer) increases the conductivity of the separator in the overcharged state. For example, 5XPT which has a greater concentration of the electroactive polymer than 5XPT, had a lesser voltage value than 5XPT. Lowest cell potential was achieved at 4.15 V for 5XPT, which had 4-times concentration of PAT than 5XPT. Therefore, formulation modifications can allow for tuning of overvoltage. Film formulation can be optimized for overcharge control. Film formulation includes electroactive polymer concentration, thickness, and pore size and distribution. A large dynamic range is available for overcharge protection with the separator film by changing the loading of P3HT in the separator.

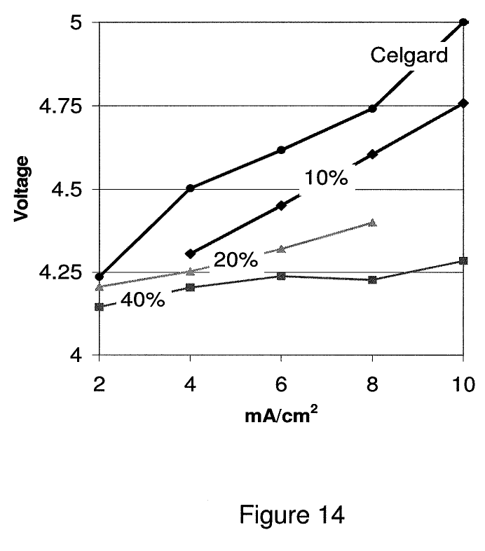

FIG. 14 shows controlling overvoltage by changing the level of P3HT. FIG. 14 shows that the overvoltage increases with applied current and by increasing the content of P3HT this overvoltage decreases. The extent of overvoltage can be tuned with the fraction of P3HT. At 40 wt % loading of P3HT in the separator, there is nearly a 0.75 voltage difference relative to the Celgard control at 10 mA/cm². Maintaining a low cell voltage can limit electrode and electrolyte damage and result in longer cycle and calendar life.

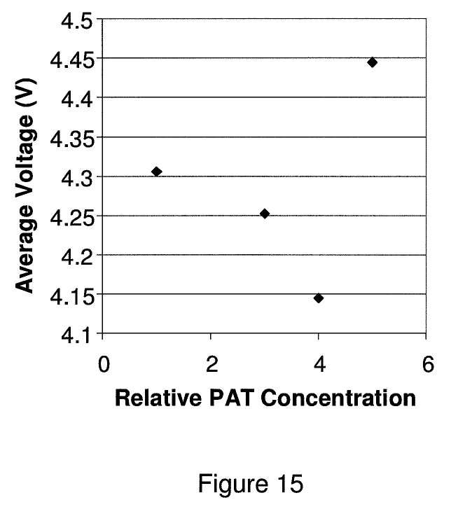

FIG. 15 shows the effect of concentration of the electroactive polymer in a separator. Specifically, FIG. 15 shows the effect of poly(alkylhiophene) (PAT) concentration in the film on the average voltage of the cell. The 4-times concentration of PAT results in lower potential. Adding more of the conductive phase increases the conductivity of the separator in the overcharged state and improved conductivity results in a lowering of the cell potential. The benefits of having a lower potential is that there is less electrochemical damage (side reactions) at the electrodes and resistive heating is lower. Based on the power relationship:

P=i²R=iV, (1)

where P is J/s, i is amps, R is ohms, and V is volts, ten second charging produces a temperature rise of less than 3° C. in the electrolyte-filled electrode assembly. This assumes a heat capacity of 2 J/gK for the electrode assembly. As noted in FIG. 14, a separator having 5-times the concentration of PAT exhibited a higher voltage level, which may be attributed to a limited porosity or lack a conductive pathway.

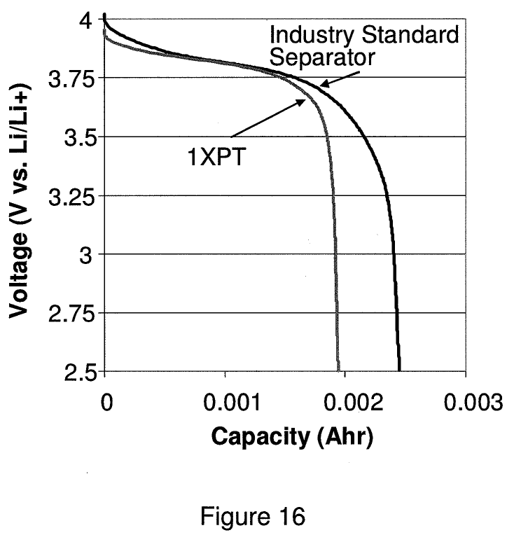

FIG. 16 shows the electrochemical performances of an industry standard separator compared with a separator. Specifically, a 5XPT separator was evaluated at a C/2 discharge rate and compared to an industry standard separator. The lower initial voltage is attributed to potential at which the 5XPT switches from a conductor to an insulator. The cell potential is lower due to higher concentration polarization created by the separator's tortuous porosity. FIG. 16 shows that 5XPT had a 3.9 V switching potential for 5XPT which resulted in a lower initial voltage and lower capacity. An additional factor was also that 5XPT had a higher porosity and was a thinner separator.

In this embodiment, the measured low capacity fade for a fully charged cell is 1%/day, which is below the 2.8% daily fade specification for the 42V USABC power assist battery. The electrical resistance of the experimental separator, in its insulative state, is compatible with industry standard separators.

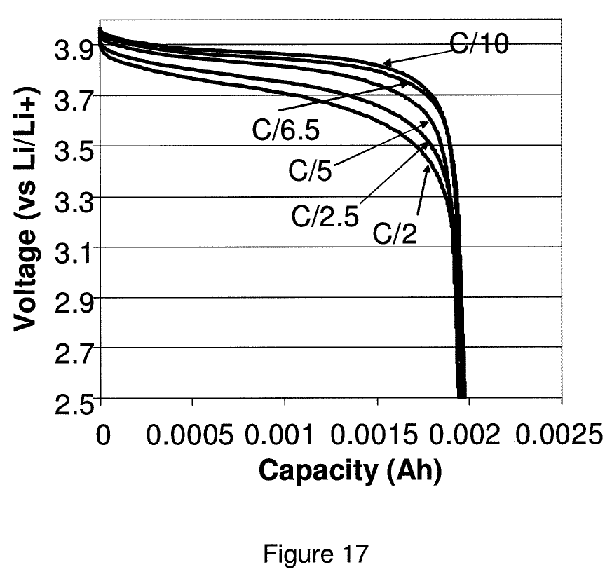

FIG. 17 shows the discharge curves of the experimental separator. FIG. 17 shows discharge curves at c-rates from C/10 to C/2. Within this range of testing, the electroactive separator was able to discharge to the same capacity. There is expected to be a greater challenge for this separator to perform at high rates due to its fine pore structure, but this data indicates that the separator is stable in the lithium ion cell and does not consume lithium nor collapse after 25 hours of testing for greater than six cycles.

The in-situ porosity of these experimental separators has higher tortuosity because of its sub-micron lenticular pores, as observed by SEM, rather than the straight-thru porosity of industry standard separators. Electrolyte mobility remains high for the experimental separator due to the decreased thickness and increased porosity. This electroactive film is 12 μm thick and 60% porous while typical separators are 25 μm thick and 37% porous.

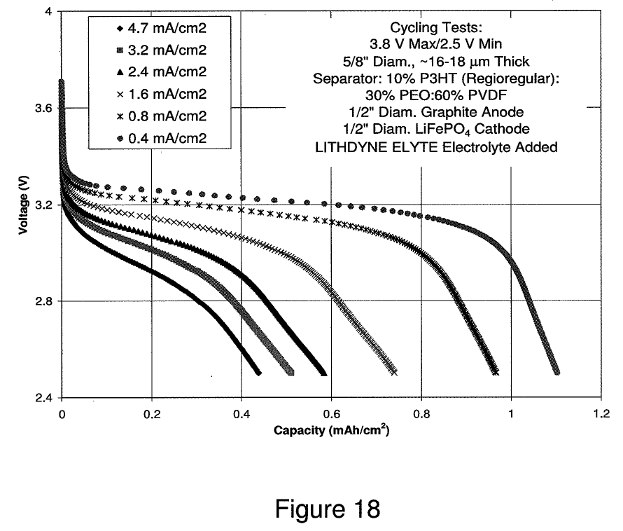

FIG. 18 shows the capacity as a function of discharge rate. FIG. 18 shows the discharge capability of a separator from 0.4 mA/cm² (C/3-rate) to 4.7 mA/cm² (3.6 C-rate). For example, a charging rate of 0.4 mA/cm². yields a capacity of 1.32 mAh/cm². The separator can display a similar discharge voltage trace to that of the Celgard control.

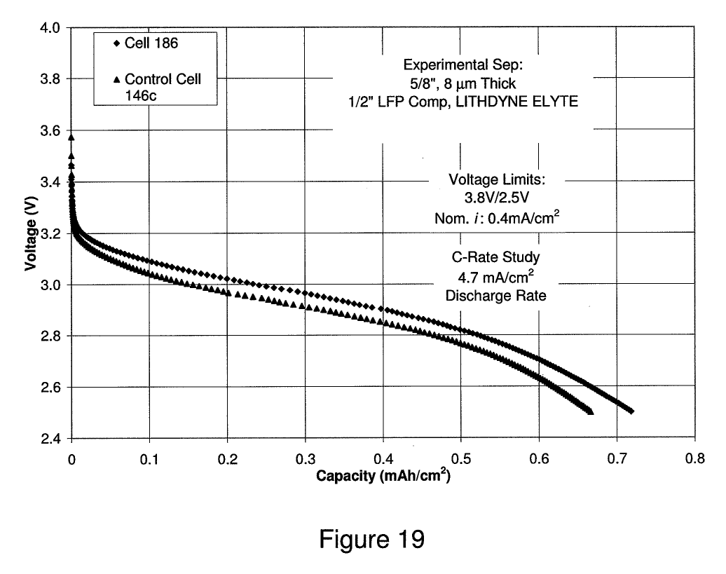

FIG. 19 shows capacity as a function of discharge rate for an electroactive composite polymer separator. In this embodiment, an 8 μm thick separator was tested. The discharge rate experienced by the separator during testing ended up to be 4.7 mA/cm².

With regards to thermal and mechanical stability of separator, no separator thermal runaway is expected at 10 mA/cm². The mechanical properties of the separator can permit roll to roll manufacture. A lithium ion battery separator can have sufficient mechanical integrity for roll-to-roll processing for the assembly of a battery. About 0.16 N/mm tensile strength force normalized to film width can be achieved. In some embodiments, the separator has similar properties to Celgard, but with built in overcharge protection. The separator can become conductive during runaway and can stabilize overvoltage. A large dynamic range is available for overcharge protection design depending on the type of electractive polymer and concentration in the separator film. The separator can provide improved safety with its tortious porosity that blocks lithium dendrites.

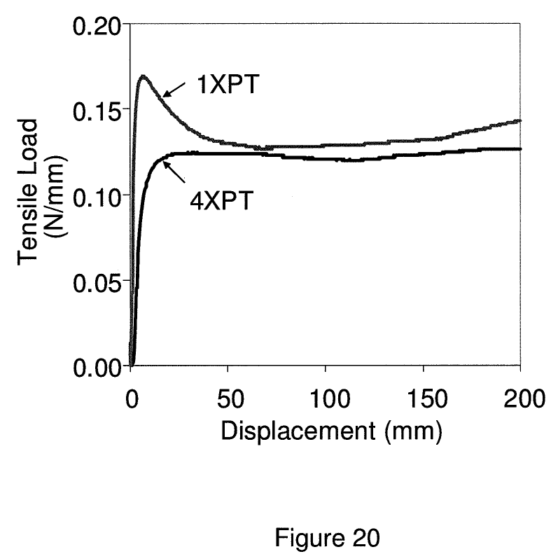

FIG. 20 shows the tensile load for two separator films. Using ASTM standard D882-02, the tensile load and yield strength of the film was measured using an Instron 4442 tensile tester. The tensile load of the electroactive separator film approaches the load required for roll-to-roll winding. The yield strength of sample 5XPT is 6.8 MPa, based on the load and cross-sectional area of the film. Poly(alkylthiophene) has a low tensile strength, so the addition of 4 times the loading of PAT, sample 5XPT, is expected to have a lower strength than sample 5XPT. The strength of the film needs to be increased by 15%, which can be addressed by adding a more rigid polymer to increase the separator's strength. This polymer can either be the electrolyte soluble component or binder component of the film.

The yield strength of the separator film makes it possible to make 15 mm free-standing films because pores are created in the cell. It is advantageous for film to have sufficient tensile strength for roll-to-roll processing for battery assembly. The addition of more of the electroactive polymer decreases tensile strength. However, the addition of a more rigid binder or electrolyte soluble polymer can increase tensile strength. If strength is not sufficient, removable backing can be used. With material selection, the cut-off voltage can be tuned for the desired battery couple. In addition, the separator can carry sufficient tensile load to be processed with conventional winding equipment.

While the invention has been particularly shown and described with reference to specific illustrative embodiments, it should be understood that various changes in form and detail may be made without departing from the spirit and scope of the invention.

What is claimed is:

1. A separator for a battery comprising:
a first polymer to provide structural support;
a second polymer mixed with the first polymer and providing an open channel for ionic transport through the separator; and
a third polymer interspersed with the first polymer and the second polymer, the third polymer being an insulator when a potential in the battery is lesser than a switching voltage and being a conductor when the potential in the battery is greater than the switching voltage.

2. The separator of claim 1 wherein the first polymer is poly(vinylidene difluoride), the second polymer is poly(ethylene oxide) and the third polymer is poly(3-hexythiophene).

3. The separator of claim 1 wherein the separator has a thickness of about 8 μm to 25 μm.

4. The separator of claim 1 wherein the separator has a tortuosity factor of about 3.

5. The separator of claim 1 wherein the third polymer controls the switching voltage.

6. The separator of claim 1 wherein the third polymer is interspersed with the first and second polymer without compromising a porosity of the separator.

7. The separator of claim 1 wherein the third polymer is reversibly switchable between the conductor and the insulator.

8. The separator of claim 1 wherein the switching voltage is about 3.6 V to 3.95V.

9. The separator of claim 1 wherein the first polymer has a weight percentage of about 10% to about 60%.

10. The separator of claim 1 wherein the second polymer has a weight percentage of about 30% to about 60%.

11. The separator of claim 1 wherein the third polymer has a weight percentage of about 10% to about 50%.

12. A method for forming a separator for a battery comprising:
dissolving at least a first polymer and a second polymer in a solvent to form a mixture;
adding a non-solvent to the mixture to form a precipitate of the first polymer and the second polymer; and
forming a layer of electroactive polymer from the precipitate.

13. The method of claim 12 wherein the first polymer is poly(ethylene oxide).

14. The method of claim 12 wherein the second polymer is a poly(vinylidene difluoride).

15. The method of claim 12 further comprising dissolving a third polymer in the solvent to form the mixture.

16. The method of claim 15 wherein the third polymer is a poly(3-hexythiophene).

17. The method of claim 12 further comprising melting the precipitate and applying pressure to the precipitate to form the separator.

18. The method of claim 12 further comprising melting the precipitate and extruding the precipitate melt to form the separator.

19. The method of claim 12 further comprising applying a shear force to the precipitate to form the separator.

20. The method of claim 12 further comprising dissolving the precipitate in a second solvent and mixing a third polymer to form a suspension.

21. The method of claim 20 further comprising casting the suspension on a film to form the separator.

22. The method of claim 21 wherein the film is a substrate for roll-to-roll processing.

23. The method of claim 21 wherein the film comprises an agent to remove the separator.

24. A battery device comprising:
anode particulates;
cathode particulates spaced from the anode particulates; and
a porous electroactive composite polymer disposed between the anode particulates and the cathode particulates to protect the battery from overcharge.
